(19) United States
(12) Patent Application Publication
(10) Pub. No.: US 2012/0194108 A1
(43) Pub. Date: Aug. 2, 2012

(54) MOTOR SYSTEM

(75) Inventors: Kota Kasaoka, Saitama (JP); Noriyuki Abe, Saitama (JP); Shigemitsu Akutsu, Saitama (JP); Hideaki Iwashita, Saitama (JP)

(73) Assignee: HONDA MOTOR CO., LTD., Tokyo (JP)

(21) Appl. No.: 13/500,077

(22) PCT Filed: Jul. 21, 2010
(86) PCT No.: PCT/JP2010/062237

§ 371 Date: Apr. 4, 2012

(30) Foreign Application Priority Data
Oct. 6, 2009 (JP) 2009-232793

(51) Int. Cl. H02P 21/14; H02P 6/08

(52) U.S. Cl. 318/400.02; 318/400.22

(57) ABSTRACT

A motor system comprises a motor (3), wherein the ratio of the number of armature magnetic poles of a stator (53), the number of magnetic poles of a first rotor (51), and the number of cores of a second rotor (52) is set to 1:m:(1+m)/2, and en ECU (60) that generates a d-axis voltage command value (V_{d}_{_{—}}c) and a q-axis voltage command (V_{q}_{_{—}}c) according to a torque command value (Tr_c), and corrects the voltage command values so as to generate a magnetic field weakening current which reduces the magnetic flex of the magnetic poles of the first rotor when the magnitude of the vector sum of the voltage command values is greater than an upper voltage limit (Vᵤₗₘₜ) set according to an output voltage (Vₒ) of a battery (11).

### BACKGROUND OF THE INVENTION

1. Field of the Invention

The present invention relates to a motor system disposed with a motor having a plurality of movers and a controller for controlling the motor.

2. Related Background Art

Hitherto, as a motor having a plurality of movers, for example, there has been known a rotary machine provided with a first rotor connected to a first rotary shaft, a second rotor connected to a second rotary shaft, and a stator (for example, refer to Japanese Patent Laid-open No. 2008-67592).

In the motor disclosed in Japanese Patent Laid-open No. 2008-67592, the first rotary shaft and the second rotary shaft are disposed concentrically, and the first rotor and the second rotor and the stator are disposed along the radial direction of the first rotary shaft from the inner side in sequence as mentioned. The first rotor is disposed with a plurality of first permanent magnets and second permanent magnets arranged along the circumferential direction thereof. The first permanent magnets and the second permanent magnets are aligned along the axial direction of the first rotor in parallel.

The second rotor is disposed with a plurality of first cores and second cores arranged along the circumferential direction thereof. The first core and the second core are made of soft magnetic material. The first core is disposed between a region to the side of the first permanent magnet of the first rotor and the stator, and the second core is disposed between a region to the side of the second permanent magnet of the first rotor and the stator.

The stator is configured to generate a first rotating magnetic field and a second rotating magnetic field, both rotating around the circumferential direction. The first rotating magnetic field is generated between a region to the side of the first permanent magnet of the first rotor and the stator, and the second rotating magnetic field is generated between a region to the side of the second permanent magnet of the first rotor and the stator. The number of the first permanent magnets and the second permanent magnets, the number of magnetic poles of the first rotating magnetic field and the second rotating magnetic field, and the number of the first cores and the second cores are identical to each other.

When supplied with an electrical power, the stator generates the first rotating magnetic field and the second rotating magnetic field; the first core and the second core are magnetized by the magnetic poles of the first rotating magnetic field and the second rotating magnetic field and the magnetic poles of the first permanent magnet and the second permanent magnet to generate magnetic lines of force therebetween. The magnetic lines of force rotate the first rotor and the second rotor to output power from the first rotary shaft and the second rotary shaft, respectively.

### SUMMARY OF THE INVENTION

### Problems to Be Solved by the Invention

Structurally, the motor disclosed in Japanese Patent Laid-open No. 2008-67592 must have a first soft magnetic material array composed of a plurality of the first cores and a second soft magnetic material array composed of a plurality of the second cores; therefore, it would be a problem that the motor has to be made large in size. According to the structure of the motor disclosed in the patent document, the velocity difference between the rotary velocity of the first rotating magnetic field and the second rotating magnetic field and the rotary velocity of the second rotor, and the velocity difference between the second rotor and the first rotor can only satisfy such a velocity relationship that the two velocity differences are identical; therefore, it would be a problem that the design freedom is low.

The present invention has been accomplished in view of the aforementioned problems, and it is therefore an object of the present invention to provide a motor in an attempt to reduce the size of the motor and to improve the design freedom thereof, and a motor system configured to extend an operable range for the motor.

### Means for Solving the Problems

To attain an object described above, the present invention provides a motor system comprising an electric motor and a section for controlling the operation of the motor. The motor is provided with a first mover composed of a magnetic pole array which has a plurality of magnetic poles arranged along a predefined direction, a stator composed of an armature array which is provided with a plurality of armatures aligned along the predefined direction, arranged opposing to the magnetic pole array and configured to generate a shifting magnetic field shifting along the predefined direction between the armature array and the magnetic pole array from armature magnetic poles generated in the plurality of armatures when applied with an electrical power, and a second mover having a core portion and another portion of a magnetic permeability lower than the core portion alternatively disposed between the magnetic pole array and the armature array along the predefined direction, and the electric motor being configured to have a ratio of the number of the armature magnetic poles and the number of the magnetic poles and the number of the core portions set to 1: m: (1+m)/2 (m≠1.0).

In the motor, when the shifting magnetic field is generated by the plural armature magnetic poles of the stator, the core portion of the second mover is magnetized by the armature magnetic poles and the magnetic poles of the first mover to generate magnetic lines of force joining the magnetic poles of the first mover and the core portion and the armature magnetic poles.

If the motor is configured according to, for example, the following conditions (a) and (b), the velocity and position relationship of the shifting magnetic field, the first mover and the second mover is denoted below. An equivalent circuit of the motor is illustrated in FIG. 9.

(a) The motor is a rotary machine, and the stator 100 is disposed with the armatures 101, 102 and 103 of 3 phases of U, V and W.

(b) The number of the armature magnetic poles is 2 and the number of the magnetic poles 111 of the first mover 110 is 4, in other words, if the N pole and the S pole of the armature magnetic pole are set as one pair, then the paired pole number of the armature magnetic poles would be 1; if the N pole and the S pole of the magnetic poles 111 of the first mover 110 are set as one pair, then the paired pole number thereof would be 2. The number of the core portions of the second mover 112 is 3 (121, 122 and 123).

In the specification, the paired pole denotes a pair of N pole and S pole.

Thus, the magnetic flux ψₖ₁ of a magnetic pole passing through the first core 121 among the 3 core portions can be denoted by the following expression (1).

[Expression 1]

ψₖ₁=ψ_{f}·cos [2(θ₂−θ₁)] (1)

Wherein, ψ_{f}: the maximum magnetic flux of the magnetic pole, θ₁: the rotating angle of the magnetic pole with respect to the U-phase coil, and θ₂: the rotating angle of the first core 121 with respect to the U-phase coil.

Therefore, the magnetic flux ψᵤ₁ of the magnetic pole passing through U-phase coil by the intermediary of the first core 121 can be denoted by the following expression (2) with the expression (1) multiplied by cos θ₂.

[Expression 2]

ψᵤ₁=ψ_{f}·cos [2(θ₂−θ₁)]·cos θ₂ (2)

Similarly, the magnetic flux ψₖ₂ of a magnetic pole passing through the second core 122 can be denoted by the following expression (3).

$$\begin{matrix}[ Expression 3 ] & \\ {ψ}_{k 2} = {ψ}_{f} \cdot cos [ 2 ( {θ}_{2} + \frac{2 π}{3} - {θ}_{1} ) ] & ( 3 )\end{matrix}$$

Since the rotating angle of the second core 122 with respect to the U-phase coil advances the rotating angle of the first core 121 by 2π/3, therefore, 2π/3 is added to θ₂ in the expression (3).

Therefore, the magnetic flux ψᵤ₂ of the magnetic pole passing through U-phase coil by the intermediary of the second core 122 can be denoted by the following expression (4) having the expression (3) multiplied by cos(θ+2π/3).

$$\begin{matrix}[ Expression 4 ] & \\ {ψ}_{u 2} = {ψ}_{f} \cdot cos [ 2 ( {θ}_{2} + \frac{2 π}{3} - {θ}_{1} ) ] \cdot cos ( {θ}_{2} + \frac{2 π}{3} ) & ( 4 )\end{matrix}$$

Similarly, the magnetic flux ψᵤ₃ of the magnetic pole passing through U-phase coil by the intermediary of the third core 123 can be denoted by the following expression (5).

$$\begin{matrix}[ Expression 5 ] & \\ {ψ}_{u 3} = {ψ}_{f} \cdot cos [ 2 ( {θ}_{2} + \frac{4 π}{3} - {θ}_{1} ) ] \cdot cos ( {θ}_{2} + \frac{4 π}{3} ) & ( 5 )\end{matrix}$$

In the motor illustrated in FIG. 9, the magnetic flux ψᵤ of the magnetic poles passing through the U-phase coil by the intermediary of the core portions 121, 122 and 123 can be denoted by the following expression (6) by adding up the magnetic flux ψᵤ₁ denoted by the expression (2), the magnetic flux ψᵤ₂ denoted by the expression (4) and the magnetic flux ψᵤ₃ denoted by the expression (5).

$$\begin{matrix} [ Expression 6 ] & \\ {ψ}_{u} = {ψ}_{f} \cdot cos [ 2 ( {θ}_{2} - {θ}_{1} ) ] \cdot cos {θ}_{2} + {ψ}_{f} \cdot cos [ 2 ( {θ}_{2} + \frac{2 π}{3} - {θ}_{1} ) ] \cdot cos ( {θ}_{2} + \frac{2 π}{3} ) + {ψ}_{f} \cdot cos [ 2 ( {θ}_{2} + \frac{4 π}{3} - {θ}_{1} ) ] \cdot cos ( {θ}_{2} + \frac{4 π}{3} ) & ( 6 )\end{matrix}$$

If the expression (6) is generalized, then, the magnetic flux ψᵤ of the magnetic poles passing through the U-phase coil by the intermediary of the core portions 121, 122 and 123 of the second mover 120 can be denoted by the following expression (7).

$$\begin{matrix} [ Expression 7 ] & \\ {ψ}_{u} = {\sum }_{i = 1}^{b} {ψ}_{f} \cdot cos \{ a [ {θ}_{2} + ( i - 1 ) \frac{2 π}{b} - {θ}_{1} ] \} cos \{ c [ {θ}_{2} + ( i - 1 ) \frac{2 π}{b} ] \} & ( 7 )\end{matrix}$$

Wherein, a: the paired pole number of the magnetic poles of the first mover, b: the number of the core portions of the second mover, and c: the paired pole number of the armature magnetic poles of the stator.

The following expression (8) can be obtained by transforming the above expression (7).

$$\begin{matrix} [ Expression 8 ] & \\ {ψ}_{u} = {\sum }_{i = 1}^{b} \frac{1}{2} \cdot {ψ}_{f} \{ cos [ ( a + c ) {θ}_{2} - a \cdot {θ}_{1} + ( a + c ) ( i - 1 ) \frac{2 π}{b} ] + cos [ ( a - c ) {θ}_{2} - a \cdot {θ}_{1} + ( a - c ) ( i - 1 ) \frac{2 π}{b} ] \} & ( 8 )\end{matrix}$$

Given that b=a+c and cos(θ+2π)=cos θ, then, the following expression (9) can be obtained by simplifying the above expression (8).

$$\begin{matrix} [ Expression 9 ] & \\ {ψ}_{u} = \frac{b}{2} \cdot {ψ}_{f} \cdot cos [ ( a + c ) {θ}_{2} - a \cdot {θ}_{1} ] + {\sum }_{i = 1}^{b} \frac{1}{2} \cdot {ψ}_{j} \{ cos [ ( a - c ) {θ}_{2} - a \cdot {θ}_{1} + ( a - c ) ( i - 1 ) \frac{2 π}{b} ] \} & ( 9 )\end{matrix}$$

If the above expression (9) is further simplified, then, the following expression (10) can be obtained.

$$\begin{matrix} [ Expression 10 ] & \\ {ψ}_{u} = \frac{b}{2} \cdot {ψ}_{f} \cdot cos [ ( a + c ) {θ}_{2} - a \cdot {θ}_{1} ] + \frac{1}{2} \cdot {ψ}_{f} \cdot cos [ ( a - c ) {θ}_{2} - a \cdot {θ}_{1} ] {\sum }_{i = 1}^{b} cos [ ( a - c ) ( i - 1 ) \frac{2 π}{b} ] - \frac{1}{2} \cdot {ψ}_{f} \cdot sin [ ( a - c ) {θ}_{2} - a \cdot {θ}_{1} ] {\sum }_{i = 1}^{b} sin [ ( a - c ) ( i - 1 ) \frac{2 π}{b} ] & ( 10 )\end{matrix}$$

If the second term at the right side of the above expression (10) is simplified on such a condition that a−c≠0, then, the value of the second term becomes zero as illustrated by the following expression (11).

$$\begin{matrix} [ Expression 11 ] & \\ \begin{matrix}{\sum }_{i = 1}^{b} cos [ ( a - c ) ( i - 1 ) \frac{2 π}{b} ] = {\sum }_{i = 0}^{b - 1} \frac{1}{2} \{ {e}^{j [ ( a - c ) \frac{2 π}{b} i ]} + {e}^{- j [ ( a - c ) \frac{2 π}{b} i ]} \} \\ = \frac{1}{2} \{ \frac{{e}^{j [ ( a - c ) \frac{2 π}{b} b ]} - 1}{{e}^{j [ ( a - c ) \frac{2 π}{b} ]} - 1} + \frac{{e}^{- j [ ( a - c ) \frac{2 π}{b} b ]} - 1}{{e}^{- j [ ( a - c ) \frac{2 π}{b} ]} - 1} \} \\ = \frac{1}{2} \{ \frac{{e}^{j [ ( a - c ) 2 π ]} - 1}{{e}^{j [ ( a - c ) \frac{2 π}{b} ]} - 1} + \frac{{e}^{- j [ ( a - c ) 2 π ]} - 1}{{e}^{- j [ ( a - c ) \frac{2 π}{b} ]} - 1} \} \\ = \frac{1}{2} \{ \frac{0}{{e}^{j [ ( a - c ) \frac{2 π}{b} ]} - 1} + \frac{0}{{e}^{- j [ ( a - c ) \frac{2 π}{b} ]} - 1} \} \\ = 0\end{matrix} & ( 11 )\end{matrix}$$

Similarly, if the third term at the right side of the above expression (10) is simplified on such a condition that a−c≠0, then, the value of the third term becomes zero as illustrated by the following expression (12).

$$\begin{matrix} [ Expression 12 ] & \\ \begin{matrix}{\sum }_{i = 1}^{b} sin [ ( a - c ) ( i - 1 ) \frac{2 π}{b} ] = {\sum }_{i = 0}^{b - 1} \frac{1}{2} \{ {e}^{j [ ( a - c ) \frac{2 π}{b} i ]} - {e}^{- j [ ( a - c ) \frac{2 π}{b} i ]} \} \\ = \frac{1}{2} \{ \frac{{e}^{j [ ( a - c ) \frac{2 π}{b} b ]} - 1}{{e}^{j [ ( a - c ) \frac{2 π}{b} ]} - 1} - \frac{{e}^{- j [ ( a - c ) \frac{2 π}{b} b ]} - 1}{{e}^{- j [ ( a - c ) \frac{2 π}{b} ]} - 1} \} \\ = \frac{1}{2} \{ \frac{{e}^{j [ ( a - c ) 2 π ]} - 1}{{e}^{j [ ( a - c ) \frac{2 π}{b} ]} - 1} - \frac{{e}^{- j [ ( a - c ) 2 π ]} - 1}{{e}^{- j [ ( a - c ) \frac{2 π}{b} ]} - 1} \} \\ = \frac{1}{2} \{ \frac{0}{{e}^{j [ ( a - c ) \frac{2 π}{b} ]} - 1} - \frac{0}{{e}^{- j [ ( a - c ) \frac{2 π}{b} ]} - 1} \} \\ = 0\end{matrix} & ( 12 )\end{matrix}$$

According to the above descriptions, when a−c≠0, then, the magnetic flux ψᵤ of the magnetic poles passing through the U-phase coil of the stator 100 by the intermediary of the core portions 121, 122 and 123 of the second mover 120 can be denoted by the following expression (13).

$$\begin{matrix}[ Expression 13 ] & \\ {ψ}_{u} = \frac{b}{2} \cdot {ψ}_{f} \cdot cos [ ( a + c ) {θ}_{2} - a \cdot {θ}_{1} ] & ( 13 )\end{matrix}$$

In the above expression (13), given that a/c=α, then, the following expression (14) can be obtained.

$$\begin{matrix}[ Expression 14 ] & \\ {ψ}_{u} = \frac{b}{2} \cdot {ψ}_{f} \cdot cos [ ( α + 1 ) c \cdot {θ}_{2} - α \cdot c \cdot {θ}_{1} ] & ( 14 )\end{matrix}$$

In the above expression (14), given that c·θ₂=θₑ₂ and c·θ₁=θₑ₁, then, the following expression (15) can be obtained.

$$\begin{matrix}[ Expression 15 ] & \\ {ψ}_{u} = \frac{b}{2} \cdot {ψ}_{f} \cdot cos [ ( α + 1 ) {θ}_{e 2} - α \cdot {θ}_{e 1} ] & ( 15 )\end{matrix}$$

Since it is obvious that θₑ₂ is obtained by multiplying the rotating angle θ₂ of the core portion with respect to the U-phase coil by the paired pole number c of the armature magnetic poles, then, θₑ₂ denotes the electric angle of the core portion with respect to the U-phase coil. Similarly, since it is obvious that θₑ₁ is obtained by multiplying the rotating angle θ₁ of the magnetic pole of the first mover 110 with respect to the U-phase coil by the paired pole number c of the armature magnetic poles, then, θₑ₁ denotes the electrical angle of the magnetic pole with respect to the U-phase coil.

Similarly, since the electrical angle of the V-phase coil lags behind the U-phase coil by the electrical angle 2π/3, then, the magnetic flux ψᵥ of the magnetic poles passing through the V-phase coil by the intermediary of the core portions can be denoted by the following expression (16).

$$\begin{matrix}[ Expression 16 ] & \\ {ψ}_{v} = \frac{b}{2} \cdot {ψ}_{f} \cdot cos [ ( α + 1 ) {θ}_{e 2} - α \cdot {θ}_{e 1} - \frac{2 π}{3} ] & ( 16 )\end{matrix}$$

Since the electrical angle of the W-phase coil advances the U-phase coil by the electrical angle 2π/3, then, the magnetic flux ψ_{w} of the magnetic poles passing through the W-phase coil by the intermediary of the core portions can be denoted by the following expression (17).

$$\begin{matrix}[ Expression 17 ] & \\ {ψ}_{w} = \frac{b}{2} \cdot {ψ}_{f} \cdot cos [ ( α + 1 ) {θ}_{e 2} - α \cdot {θ}_{e 1} + \frac{2 π}{3} ] & ( 17 )\end{matrix}$$

Differentiating the magnetic fluxes ψᵤ, ψᵥ and ψ_{w} denoted by the expressions (15) to (17) over time, the following expressions (18) to (20) can be obtained.

$$\begin{matrix} [ Expression 18 ] & \\ \frac{d {ψ}_{u}}{d t} = - \frac{b}{2} \cdot {ψ}_{f} \{ [ ( α + 1 ) {ω}_{e 2} - α \cdot {ω}_{e 1} ] sin [ ( α + 1 ) {θ}_{e 2} - α \cdot {θ}_{e 1} ] \} & ( 18 ) \\ [ Expression 19 ] & \\ \frac{d {ψ}_{v}}{d t} = - \frac{b}{2} \cdot {ψ}_{f} \{ [ ( α + 1 ) {ω}_{e 2} - α \cdot {ω}_{e 1} ] sin [ ( α + 1 ) {θ}_{e 2} - α \cdot {θ}_{e 1} - \frac{2 π}{3} ] \} & ( 19 ) \\ [ Expression 20 ] & \\ \frac{d {ψ}_{w}}{d t} = - \frac{b}{2} \cdot {ψ}_{f} \{ [ ( α + 1 ) {ω}_{e 2} - α \cdot {ω}_{e 1} ] sin [ ( α + 1 ) {θ}_{e 2} - α \cdot {θ}_{e 1} + \frac{2 π}{3} ] \} & ( 20 )\end{matrix}$$

Wherein, ωₑ₁: temporal differentiation value of θₑ₁ (a converted value of the angular velocity of the first mover with respect to the stator into the electrical angular velocity), and ωₑ₂: temporal differentiation value of θₑ₂ (a converted value of the angular velocity of the second mover with respect to the stator into the electrical angular velocity).

Here, the magnetic fluxes passing through the coils of U phase, V phase and W phase without the intermediary of the core portions 121, 122 and 123 are extremely small, the influence thereof can be ignored. Thus, the temporal differentiation values dψᵤ/dt, dψᵥ/dt and dψ_{w}/dt of the magnetic fluxes ψᵤ, ψᵥ, and ψ_{w} (denoted by the above expressions (18) to (20), respectively,) of the magnetic poles passing through the coils of U phase, V phase and W phase by the intermediary of the core portions 121, 122 and 123, respectively, denotes counter electromotive voltages (induced electromotive voltages) occurred in the coils of U phase, V phase and W phase, respectively, as the magnetic poles of the first mover 110 and the core portions of the second mover 120 rotate (shift) with respect to the armature array of the stator 100.

Thereby, the current Iᵤ flowing in the U-phase coil, the current Iᵥ flowing in the V-phase coil and the current I_{W} flowing in the W-phase coil can be denoted by the following expressions (21), (22) and (23), respectively.

[Expression 21]

Iᵤ=I·sin [(α+1)θₑ₂−α·θₑ₁] (21)

$$\begin{matrix}[ Expression 22 ] & \\ {I}_{v} = I \cdot sin [ ( α + 1 ) {θ}_{e 2} - α \cdot {θ}_{e 1} - \frac{2 π}{3} ] & ( 22 ) \\ [ Expression 23 ] & \\ {I}_{w} = I \cdot sin [ ( α + 1 ) {θ}_{e 2} - α \cdot {θ}_{e 1} + \frac{2 π}{3} ] & ( 23 )\end{matrix}$$

Wherein, I: the amplitude (maximum value) of the current flowing in the coils of U phase, V phase and W phase.

On the basis of the above expressions (21), (22) and (23), the electrical angle θ_{mf} of a vector of the shifting magnetic field (the rotating magnetic field) with respect to the U-phase coil is denoted by the following expression (24), and the electrical angular velocity ω_{mf} of the shifting magnetic field with respect to the U-phase coil is denoted by the following expression (25).

[Expression 24]

θ_{mf}=(α+1)·θₑ₂−α·θₑ₁ (24)

[Expression 25]

ω_{mf}=(α+1)·ωₑ₂−α·ωₑ₁ (25)

Due to the current Iᵤ flowing in the U-phase coil, Iᵥ flowing in the V-phase coil and I_{w} flowing in the W-phase coil, the mechanical output (dynamic power) W output to the first mover and the second mover is denoted by the following expression (26), without taken into consideration the magnetic reluctance.

$$\begin{matrix}[ Expression 26 ] & \\ W = \frac{d {ψ}_{u}}{d t} \cdot {I}_{u} + \frac{d {ψ}_{v}}{d t} \cdot {I}_{v} + \frac{d {ψ}_{w}}{d t} \cdot {I}_{w} & ( 26 )\end{matrix}$$

Assigning the above expressions (18) to (23) into the above expression (26), the following expression (27) can be obtained.

$$\begin{matrix}[ Expression 27 ] & \\ W = - \frac{3 b}{4} \cdot {ψ}_{f} \cdot I [ ( α + 1 ) {ω}_{e 2} - α \cdot {ω}_{e 1} ] & ( 27 )\end{matrix}$$

Moreover, the relationship between the mechanical output W and a torque transmitted to the first mover by the intermediary of the magnetic poles (hereinafter, referred to aas the first torque) T₁, a torque transmitted to the second mover by the intermediary of the core portions (hereinafter, referred to as the first torque) T₂, the electrical angular velocity ωₑ₁ of the first mover and the electrical angular velocity ωₑ₂ of the second mover can be denoted by the following expression (28).

[Expression 28]

W=T₁·ωₑ₁+T₂·ωₑ₂ (28)

By comparing the expression (27) and the expression (28) in the above, the first torque T₁ and the second torque T₂ can be denoted by the following expressions (29) and (30), respectively.

$$\begin{matrix}[ Expression 29 ] & \\ {T}_{1} = α \cdot \frac{3 b}{4} \cdot {ψ}_{f} \cdot I & ( 29 ) \\ [ Expression 30 ] & \\ {T}_{2} = - ( α + 1 ) \cdot \frac{3 b}{4} \cdot {ψ}_{f} \cdot I & ( 30 )\end{matrix}$$

If the torque, which is equivalent to the electrical power supplied to the armature array and the electrical angular velocity ω_{mf} of the shifting magnetic field, is denoted by an equivalent drive torque Tₑ, the electrical power supplied to the armature array is equal to the mechanical output W with the loss ignored; then, the equivalent drive torque Tₑ can be denoted by the following expression (31) on the basis of the above expressions (25) and (27).

$$\begin{matrix}[ Expression 31 ] & \\ {T}_{e} = \frac{3 b}{4} \cdot {ψ}_{f} \cdot I & ( 31 )\end{matrix}$$

Further, on the basis of the above expressions (29) to (31), the following expression (32) can be obtained.

$$\begin{matrix}[ Expression 32 ] & \\ {T}_{e} = \frac{{T}_{1}}{α} = \frac{- {T}_{2}}{α + 1} & ( 32 )\end{matrix}$$

The torque relationship denoted by the above expression (32) and the electrical angular velocity relationship denoted by the above expression (25) are completely identical to the rotating velocity relationship and the torque relationship of a sun gear, a ring gear and a carrier gear in a planetary gear device.

As mentioned in the above, the electrical angular velocity relationship denoted by the above expression (25) and the torque relationship denoted by the above expression (32) hold on the condition that b=a+c and a−c≠0. When the number of the magnetic poles is denoted by p and the number of the armature magnetic poles by q, the condition of b=a+c can be written in the form of b=(p+q)/2, namely b/q=(1+p/q)/2.

Here, given that p/q=m, then, b/q=(1+m)/2; the validation of the condition of b=a+c means that the ratio of the number of the armature magnetic poles and the number of the magnetic poles and the number of the core portions is 1: m: (1+m)/2. The validation of the condition of a−c≠0 means that m≠1.0.

In the motor of the present invention, the ratio of the number of the armature magnetic poles and the number of the magnetic poles and the number of the core portions is set to 1: m: (1+m)/2 (m≠1.0) in a predefined section along a predefined direction; therefore, it is obvious that the electrical angular velocity relationship denoted by the above expression (25) and the torque relationship denoted by the above expression (32) are valid, and the motor will work properly.

Different from the conventional art described in the above, since the second mover is constituted from a single array of core portions, it is possible to make the motor smaller in size. Further, as obviously observed from the above expressions (25) and (32), by setting α=a/c, in other words, by setting the ratio of the paired pole number of the magnetic poles with respect to the paired pole number of the armature magnetic poles, it is possible to arbitrarily configure the electrical angular velocity relationship among the shifting magnetic field, the first mover and the second mover and the torque relationship among the stator, the first mover and the second mover.

Thereby, it is possible to improve the design freedom of the motor. In addition, the mentioned effects can be obtained as well when the phases of the coils in plural armatures are not the same as the 3 phases mentioned in the above, or when the motor is not a rotary machine but a directing acting machine (linear motor). In the case of the linear motor, it is not the torque relationship but the thrust relationship that can be arbitrarily configured.

[First Aspect of the Present Invention]

The motor system according to the first aspect of the present invention is provided with the motor mentioned above, a power source, a controller configured to determine a voltage command value which is a command value of a voltage to be supplied to coils of the armature according to a predefined required operation state, and correct the voltage command value so as to generate a magnetic field weakening current to reduce a magnetic flux of the magnetic poles on condition that the voltage command value is greater than an upper voltage limit set according to an output voltage of the power source or a velocity of the shifting magnetic field is greater than a predefined upper velocity limit, and a drive circuit configured to generate a drive voltage from the output power of the power source according to the voltage command value and supply the drive voltage to the coils of the armature.

In the first aspect of the present invention, if the voltage command value is greater than the upper voltage limit, it is impossible to increase the current to be supplied to the motor and the torque of the motor reaches its peak, it would be difficult to control the operation state of the motor at the required operation state.

Therefore, when the voltage command value is greater than the upper voltage limit, the voltage command value is corrected by the controller so as to generate the magnetic field weakening current to reduce the magnetic flux of the magnetic poles, thereby, the counter electromotive force generated in the armature is reduced, which makes it possible to increase the available amount of current to be supplied to the motor. Consequently, it is possible to extend the available control range of the motor.

Further, in the first aspect of the present invention, if the velocity of the shifting magnetic field is greater than the upper velocity limit, the counter electromotive force generated in the armature would become greater, which reduces the available amount of current to be supplied to the coils of the armature. Thus, the torque of the motor decreases, it would be difficult to control the operation state of the motor at the required operation state.

Therefore, when the velocity of the shifting magnetic field is greater than the upper velocity limit, the voltage command value is corrected by the controller so as to generate the magnetic field weakening current to reduce the magnetic flux of the magnetic poles, thereby, the counter electromotive force generated in the armature is reduced, which makes it possible to increase the available amount of current to be supplied to the motor. Consequently, it is possible to extend the available control range of the motor.

In the first aspect of the present invention, when the controller is correcting the voltage command value so as to cause the drive circuit to supply the drive voltage to the coils of the armature, the controller stops correcting the voltage command value on condition that the voltage command value becomes equal to or lower than the upper voltage limit (Second aspect of the present invention).

According to the second aspect of the present invention, when the voltage command value becomes equal to or lower than the upper voltage limit, the correction of the voltage command value is stopped by the controller; thereby, the loss of the motor resulted from the current applied for the purpose of the correction can be prevented.

In the first aspect of the present invention, when the controller is correcting the voltage command value so as to cause the drive circuit to supply the drive voltage to the coils of the armature on condition that the velocity of the shifting magnetic field is greater than the upper velocity limit, the controller stops correcting the voltage command value on condition that the velocity of the shifting magnetic field becomes equal to or lower than the upper velocity limit (Third aspect of the present invention).

According to the third aspect of the present invention, when the voltage command value becomes equal to or lower than the upper voltage limit, the correction of the voltage command value is stopped by the controller; thereby, the loss resulted from the current applied for the purpose of the correction can be prevented from occurring in the motor.

[Fourth Aspect of the Present Invention]

The motor system according to the fourth aspect of the present invention is provided with the motor mentioned above, a power source, a booster circuit configured to boost an output voltage of the power source, a controller configured to determine a voltage command value which is a command value of a voltage to be supplied to coils of the armature according to a predefined required operation state, and cause the booster circuit to boost the output voltage of the power source on condition that the voltage command value is greater than an upper voltage limit set according to an output voltage of the power source or a velocity of the shifting magnetic field is greater than a predefined upper velocity limit, and a drive circuit configured to generate a drive voltage from the output power of the power source according to the voltage command value and supply the drive voltage to the coils of the armature.

In the fourth aspect of the present invention, if the voltage command value is greater than the upper voltage limit, it is impossible to increase the current to be supplied to the motor and the torque of the motor reaches its peak, it would be difficult to control the operation state of the motor at the required operation state.

Therefore, when the voltage command value is greater than the upper voltage limit, the controller increase the available voltage to be supplied to the armature by causing the booster circuit to boost the output voltage of the power source, which makes it possible to increase the available amount of current to be supplied to the motor. Consequently, it is possible to extend the available control range of the motor.

Further, in the fourth aspect of the present invention, if the velocity of the shifting magnetic field is greater than the upper velocity limit, the counter electromotive force generated in the armature would become greater, which reduces the available amount of current to be supplied to the coils of the armature. Thus, the torque of the motor decreases, it would be difficult to control the operation state of the motor at the required operation state.

Therefore, when the velocity of the shifting magnetic field is greater than the upper velocity limit, the controller increases the available voltage to be supplied to the armature by causing the booster circuit to boost the output voltage of the power source, which makes it possible to increase the available amount of current to be supplied to the motor. Consequently, it is possible to extend the available control range of the motor.

In the fourth aspect of the present invention, when the controller is causing the booster circuit to boost the output voltage of the power source so as to cause the drive circuit to supply the drive voltage to the coils of the armature on condition that the voltage command value is greater than the upper voltage limit, the controller stops boosting the output voltage of the power source via the booster circuit on condition that the voltage command value becomes equal to or lower than the upper voltage limit (Fifth aspect of the present invention).

According to the fifth aspect of the present invention, when the voltage command value becomes equal to or lower than the upper voltage limit, the boost of the output voltage of the power source by the booster circuit is stopped by the controller; thereby, the loss can be prevented from occurring in the booster circuit in performing the boost.

In the fourth aspect of the present invention, when the controller is causing the booster circuit to boost the output voltage of the power source so as to cause the drive circuit to supply the drive voltage to the coils of the armature on condition that the velocity of the shifting magnetic field is greater than the upper velocity limit, the controller stops boosting the output voltage of the power source via the booster circuit on condition that the velocity of the shifting magnetic field becomes equal to or lower than the upper velocity limit (Sixth aspect of the present invention).

According to the sixth aspect of the present invention, when the velocity of the shifting magnetic field becomes equal to or lower than the upper velocity limit, the boost of the output voltage of the power source by the booster circuit is stopped by the controller; thereby, the loss can be prevented from occurring in the booster circuit in performing the boost.

[Seventh Aspect of the Present Invention]

The motor system according to the seventh aspect of the present invention is provided with the motor mentioned above, a power source, a booster circuit configured to boost an output voltage of the power source, a controller configured to determine a voltage command value which is a command value of a voltage to be supplied to coils of the armature according to a predefined required operation state, estimate a first loss occurred in performing a first process for correcting the voltage command value so as to generate a magnetic field weakening current to reduce a magnetic flux of the magnetic poles and a second loss occurred in performing a second process for causing the booster circuit to boost the output voltage of the power source on condition that the voltage command value is greater than an upper voltage limit set according to an output voltage of the power source, and determine a correcting level and a boosting level on the basis of the estimation results of the first loss and the second loss, respectively, and a drive circuit configured to generate a drive voltage from the output power of the power source according to the voltage command value and supply the drive voltage to the coils of the armature.

In the seventh aspect of the present invention, if the voltage command value is greater than the upper voltage limit, it is impossible to increase the current to be supplied to the motor and the torque of the motor reaches its peak, it would be difficult to control the operation state of the motor at the required operation state.

Therefore, when the voltage command value is greater than the upper voltage limit, the first process for correcting the voltage command value so as to generate a magnetic field weakening current to reduce a magnetic flux of the magnetic poles and the second process for causing the booster circuit to boost the output voltage of the power source are performed to increase the available amount of current to be supplied to the motor, which makes it possible to extend the available control range of the motor. On the basis of the determination results of the first loss occurred in performing the first process and the second loss occurred in performing the second process, the losses can be inhibited, which makes it possible to set appropriately the correcting level and the boosting level.

In the seventh aspect of the present invention, the controller prioritizes a process in the first process and the second process which would have a smaller loss

(Eighth Aspect of the Present Invention).

According to the eighth aspect of the present invention, by prioritizing a process in the first process and the second process which would have a smaller estimated value of loss, it is possible to further inhibit the losses, and consequently to extend the available control range of the motor.

In the seventh aspect of the present invention, the controller determines the correcting level for the first process and the boosting level for the second process to boost the output voltage of the power source so as to minimize the sum of the first loss and the second loss

(Ninth Aspect of the Present Invention).

According to the ninth aspect of the present invention, since the correcting level and the boosting level are determined so as to minimize the sum of the estimated value of the first loss occurred in performing the first process and the second loss occurred in performing the second process, it is possible to further inhibit the losses, and consequently to extend the available control range of the motor.

[Tenth Aspect of the Present Invention]

The motor system according to the tenth aspect of the present invention is provided with the motor mentioned above, a power source, a controller configured to determine a voltage command value which is a command value of a voltage to be supplied to coils of the armature according to a predefined required operation state, and a drive circuit configured to generate a drive voltage from the output power of the power source according to the voltage command value, supply the drive voltage to the coils of the armature, and switch generation behaviors for generating the drive voltage according to whether or not the voltage command value is equal to or lower than an upper voltage limit set according to an output voltage of the power source or a velocity of the shifting magnetic field is equal to or lower than a predefined upper velocity limit.

According to the tenth aspect of the present invention, the generation behaviors for generating the drive voltage according to the voltage command value are switched according to whether or not the voltage command value is equal to or lower than an upper voltage limit set according to an output voltage of the power source or a velocity of the shifting magnetic field is equal to or lower than a predefined upper velocity limit, it is possible to extend the available control range of the motor.

The drive circuit generates the drive voltage according to the voltage command value via sinusoidal energization on condition that the voltage command value is equal to or lower than the upper voltage limit, and generates the drive voltage according to the voltage command value via rectangular energization on condition that the voltage command value is greater than the upper voltage limit (Eleventh aspect of the present invention).

In the eleventh aspect of the present invention, if the voltage command value is greater than the upper voltage limit, it is impossible to increase the current to be supplied to the motor and the torque of the motor reaches its peak, it would be difficult to control the operation state of the motor at the required operation state.

Therefore, when the voltage command value is greater than the upper voltage limit, the drive circuit generates the drive voltage from the output power of the power source via sinusoidal energization according to the voltage command value so as to reduce the maximum value of the drive voltage, it is possible to increase the available amount of current to be supplied to the motor. Consequently, it is possible to extend the available control range of the motor.

In the tenth aspect of the present invention, the drive circuit generates the drive voltage according to the voltage command value by performing a 3-phase modulation to vary voltages applied to the coils of the armatures of 3 phases on condition that the voltage command value is equal to or lower than the upper voltage limit, and generates the drive voltage according to the voltage command value by performing a 2-phase modulation to vary only voltages applied to the coils of the armatures of 2 phases in the 3 phases on condition that the voltage command value is greater than the upper voltage limit (Twelfth aspect of the present invention).

According to the twelfth aspect of the present invention, when the voltage command value is greater than the upper voltage limit, the drive voltage is generated according to the voltage command value by performing a 2-phase modulation, which makes it possible to reduce the switching frequency by PWM control, and consequently, to reduce the loss resulted from the switching. Therefore, the loss resulted from the switching will be constrained in a range without surpassing a predefined level, which makes it possible to extend the available control range of the motor.

In the tenth aspect of the present invention, the drive circuit generates the drive voltage according to the voltage command value via sinusoidal energization on condition that the velocity of the shifting magnetic field is equal to or lower than the upper velocity limit, and generates the drive voltage according to the voltage command value via rectangular energization on condition that the velocity of the shifting magnetic field is greater than the upper velocity limit (Thirteenth aspect of the present invention).

According to the thirteenth aspect of the present invention, when the velocity of the shifting magnetic field is greater than the upper velocity limit, the drive voltage is generated via sinusoidal energization according to the voltage command value, which makes it possible to reduce the maximum voltage of the drive voltage. Thereby, the rotation region capable of supplying the current to the motor is extended to the high velocity side, which makes it possible to extend the available control range of the motor.

In the tenth aspect of the present invention, the drive circuit generates the drive voltage according to the voltage command value by performing a 3-phase modulation to vary voltages applied to the coils of the armatures of 3 phases on condition that the velocity of the shifting magnetic field is equal to or lower than the upper velocity limit, and generates the drive voltage according to the voltage command value by performing a 2-phase modulation to vary only voltages applied to the coils of the armatures of 2 phases in the 3 phases on condition that the velocity of the shifting magnetic field is greater than the upper velocity limit (Fourteenth aspect of the present invention).

According to the fourteenth aspect of the present invention, when the velocity of the shifting magnetic field is greater than the upper velocity limit, the drive voltage is generated according to the voltage command value by performing a 2-phase modulation, which makes it possible to reduce the switching frequency by PWM control, and consequently, to reduce the loss resulted from the switching. Therefore, the loss resulted from the switching will be constrained in a range without surpassing a predefined level, which makes it possible to extend the available control range of the motor.

### BRIEF DESCRIPTION OF THE DRAWINGS

FIG. 1 is a vertical cross-sectional view schematically illustrating a structure of a rotary machine;

FIG. 2 is an expanded view along the circumferential direction of a stator, a first rotor and a second rotor disposed in the rotary machine illustrated in FIG. 3;

FIG. 3 is a structural view of a motor system provided with the rotary machine and a controller thereof;

FIG. 4 is a correlation map between a torque and a loss resulted from a magnetic field weakening current in a predefined rotating velocity and a loss in a booster circuit;

FIG. 5 is a correlation map between a boosting rate of the booster circuit and the sum of the loss resulted from the magnetic field weakening current and the loss in the booster circuit;

FIG. 6 is a view for comparing 3-phase modulation and 2-phase modulation;

FIG. 7 is a view for comparing a correlation voltage generated according to 3-phase modulation and a correlation voltage generated according to 2-phase modulation;

FIG. 8 is a view explaining a generation method of a drive voltage generated according to 2-phase modulation; and

FIG. 9 is a view of an equivalent circuit of the motor.

### DETAILED DESCRIPTION OF THE PREFERRED EMBODIMENTS

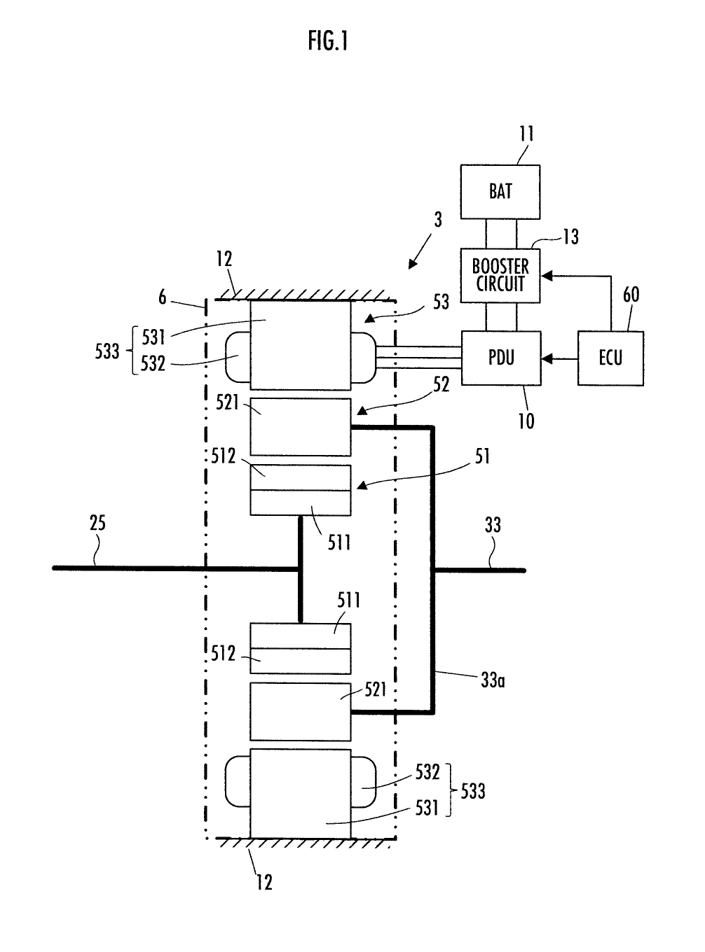

An embodiment of the present invention will be described in detail with reference to FIG. 1 to FIG. 8. With reference to FIG. 1, a motor system according to the present embodiment is provided with a rotary machine 3 (equivalent to a motor of the present invention), an ECU 60 (Electronic Control Unit, equivalent to a controller of the present invention) configured to control the performance of the rotary machine 3, a PDU 10 (Power Drive Unit) which is a drive circuit composed of an inverter circuit, a battery 11 (equivalent to a power source of the present invention), and a booster circuit 13.

The ECU 60 is an electronic circuit unit composed of a CPU, a RAM, a ROM, an interface circuit and the like, and is configured to execute a control program preliminarily installed for controlling the rotary machine 3 in the CPU so as to control the performance of the rotary machine 3.

The rotary machine 3 is disposed with a first rotor 51 (equivalent to the first mover of the present invention) which is rotatably supported in a housing 6 of the rotary machine 3 and a second rotor (equivalent to the second mover of the present invention). The first rotor 51 and the second rotor are disposed concentrically. A stator 53 (equivalent to the stator of the present invention) is fixed in the housing 6 of the rotary machine 3.

In the present embodiment, the stator 53 is disposed around the first rotor 51, facing to the first rotor 51. The second rotor 52 is disposed between the first rotor 51 and the stator 53, rotatable without contacting the first rotor 51 and the stator 53. Therefore, the first rotor 51, the second rotor 52 and the stator 53 are disposed concentrically.

Hereinafter, if not specified, “the circumferential direction” refers to a direction around the axial center of a first rotating shaft 25 extending from an axial center portion of the rotary machine 3 (the axial center portion of the first rotor 51), and “the axial direction” refers to the axial direction of the first rotating shaft 25.

The stator 53 is disposed with a plurality of armatures 533 for generating a rotating magnetic field applied to the first rotor 51 and the second rotor 52 inside the stator 53, an iron core (iron core of the armatures) 531 formed into a cylindrical shape by laminating a plurality of iron plates, and coils (armature windings) 532 of 3 phases (U, V and W phases) mounted on the inner circumferential surface of the iron core 531. The iron core 531 is inserted coaxially with the first rotating shaft 25 and fixed in the housing 6.

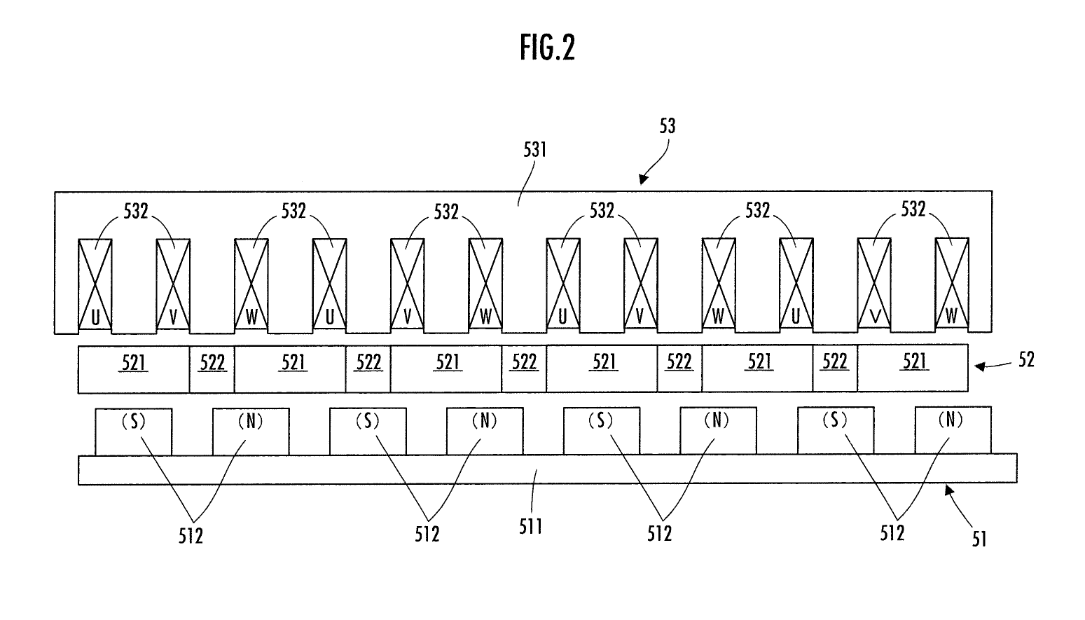

Each single armature 533 is constituted from the iron core 531 and the coils 532 of each phase of U, V and W. The coils 532 of 3 phases of U, V and W are mounted in the iron core 531, aligned in the circumferential direction (refer to FIG. 2). Thereby, an armature array is formed with a plurality (a multiple of 3) of armatures 533 aligned in the circumferential direction.

The coils 532 of 3 phases of U, V and W in the armature array are disposed in such a way that when a 3-phase alternating current is applied thereto, a plurality (even number) of armature magnetic poles are generated, aligning at even intervals in the circumferential direction and rotating along the circumferential direction on the inner circumferential surface of the iron core 531. The array of the armature magnetic poles has N pole and S pole aligned alternatively (in the array, any two adjacent armature magnetic poles have different polarity) in the circumferential direction. The stator 53 is configured to generate a rotating magnetic field inside the iron core 531 along with the rotation of the armature magnetic pole array.

The coils 532 of 3 phases are connected to the battery 11 via the PDU 10 and the booster circuit 13. The power transmission (input and output of electric energy with respect to the coils 532) is performed between the coils 532 and the battery 11 via the PDU 10. Therefore, by controlling the current applied to the coils 532 via the PDU 10 through the ECU 60, it is possible to control the formations (rotating velocity and magnetic flux strength of the rotating magnetic field) of the generated rotating magnetic field.

As illustrated in FIG. 2, the first rotor 51 is provided with a cylindrical main body 511 made of soft magnetic materials and a plurality (even number) of permanent magnets 512 (magnet magnetic poles, equivalent to the magnetic poles of the present invention) fixed at the outer circumferential surface of the main body 511. The main body 511 is formed by laminating, for example, iron plates or steel plates. The main body 511 is inserted to the first rotating shaft 25 from the inner side of the iron core 531 of the stator 53 and is fixed on the first rotating shaft 25 so as to rotate integrally with the first rotating shaft 25.

The plurality of permanent magnets 512 of the first rotor 51 are aligned at even intervals in the circumferential direction. According to the alignment of the permanent magnets 512, a magnetic pole array is formed on the outer circumferential surface of the first rotor 51 with a plurality of magnetic poles aligned in the circumferential direction and facing to the inner circumferential surface of the iron core 531 of the stator 53. As illustrated by the symbols of (N) and (S) in FIG. 2, the magnetic poles of the outer surfaces (the surface corresponding to the inner circumferential surface of the iron core 531 of the stator 53) of two adjacent permanent magnets 512 and 512 in the circumferential direction have mutually different polarity. In other words, according to the alignment of the permanent magnets 512 of the first rotor 51, the magnetic pole array formed on the outer circumferential surface of the first rotor 51 has N pole and S pole aligned alternatively.

The length of the main body 511 and the permanent magnets 512 in the first rotor 51 (the length along the axial direction of the first rotating shaft 25) is configured to be comparably equal to the length of the iron 531 of the stator 53 in the axial direction.

The second rotor 52 is comprised of a soft magnetic material array having a plurality of cores 521 (equivalent to the core portion of the present invention) aligned between the stator 53 and the first rotor 51 without contacting with the stator 53 and the first rotor 51. Each core 521 is made of soft magnetic material. The plurality of cores 521 constituting the soft magnetic material array are aligned at even intervals in the circumferential direction with a portion 522 having a magnetic permeability lower than the core 521 sandwiched therebetween.

Each core 521 is formed by laminating, for example, a plurality of steel plates. The soft magnetic material array formed by the cores 521 is fixed on a circular flange 33a formed at the top end of a second rotating shaft 33. Thereby, the second rotor 52 is enabled to rotate integrally with the second rotating shaft 33.

The length of each core 521 constituting the soft magnetic material array (the length along the axial direction of the first rotating shaft 25) is configured to be comparably equal to the length of the iron 531 of the stator 53 along the axial direction.

If the number of the armature magnetic poles of the stator 53 of the rotary machine 3 is denoted by p, the number of the magnetic poles of the first rotor 51 (the number of the permanent magnets 512) is denoted by q, and the number of the cores 521 constituting the soft magnetic material array of the second rotor 52 is denoted by r, then, p, q and r are defined to satisfy the relationship in the following expression (33).

$$\begin{matrix}[ Expression 33 ] & \\ p : q : r = 1 : m : \frac{1 + m}{2} & ( 33 )\end{matrix}$$

Wherein, m is any positive rational number and m≠1, p and q are even numbers.

For example, if p=4, q=8, r=6 and m=2, the relationship in the above expression (33) holds.

As mentioned above, in the rotary machine 3 configured to have the number p of the armature magnetic poles of the stator 53 of the rotary machine 3, the number q of the cores 521 of the second rotor 52 and the number r of the magnetic poles of the first rotor 51 (the number of the permanent magnets 512) satisfying the above expression (33), when both or either one of the first rotor 51 and the second rotor 52 rotates, the temporal variation rates dψᵤ/dt, dψᵥ/dt and dψ_{w}/dt of the magnetic fluxes (interlinked flux) applied from the magnetic poles of the first rotor 51 by the intermediary of the cores 521 of the second rotor 52 to the coils 532 of each phase in the stator 53 (herein, ψᵤ, ψᵥ, and ψ_{w} are interlinked fluxes applied to the U-phase coil, the V-phase coil and the W-phase coil, respectively) are denoted by the following expressions (34), (35) and (36), respectively.

$$\begin{matrix} [ Expression 34 ] & \\ \frac{d {ψ}_{u}}{d t} = - \frac{r}{2} \cdot {ψ}_{f} \{ [ ( m + 1 ) {ω}_{e 2} - m \cdot {ω}_{e 1} ] sin [ ( m + 1 ) {θ}_{e 2} - m \cdot {θ}_{e 1} ] \} & ( 34 ) \\ [ Expression 35 ] & \\ \frac{d {ψ}_{v}}{d t} = - \frac{r}{2} \cdot {ψ}_{f} \{ [ ( m + 1 ) {ω}_{e 2} - m \cdot {ω}_{e 1} ] sin [ ( m + 1 ) {θ}_{e 2} - m \cdot {θ}_{e 1} - \frac{2 π}{3} ] \} & ( 35 ) \\ [ Expression 36 ] & \\ \frac{d {ψ}_{w}}{d t} = - \frac{r}{2} \cdot {ψ}_{f} \{ [ ( m + 1 ) {ω}_{e 2} - m \cdot {ω}_{e 1} ] sin [ ( m + 1 ) {θ}_{e 2} - m \cdot {θ}_{e 1} + \frac{2 π}{3} ] \} & ( 36 )\end{matrix}$$

wherein, ψ_{f}: the maximum value of the magnetic flux from the magnetic poles of the first rotor 51; θₑ₂: the electrical angle of the second rotor 52 with respect to one reference coil (for example U-phase coil) among the 3-phase coils 532 of the stator 53; ωₑ₂: the electrical angular velocity of the second rotor 52; θₑ₁: the electrical angle of the first rotor 51 with respect to the reference coil; and ωₑ₁: the electrical angular velocity of the first rotor 51.

In the above expressions (34) to (36), the value of θₑ₁ is set to zero when one of the magnetic poles of the first rotor 51 is facing to the reference coil, and the value of θₑ₂ is set to zero when one of the cores 521 of the second rotor 52 is facing to the reference coil. The above-mentioned “electrical angle” refers to an angle obtained by a mechanical angle multiplied by the paired pole number of the armature magnetic poles (the number of the pairs of N pole and S pole (=p/2)).

Here, since the magnetic flux applied from the magnetic poles of the first rotor 51 directly to each coil 532 without passing through the cores 521 of the second rotor 52 is minute with respect to the magnetic flux passing through the cores 521, the dψᵤ/dt, dψᵥ/dt and dψ_{w}/dt in the above expressions (34) to (36) denote the counter electromotive power (induced electromotive voltage) occurred in the coils 532 of each phase, respectively, with the rotation of the first rotor 51 or the second rotor 52 with respect to the stator 53.

In the present embodiment, the current applied to the coils 532 of the stator 53 is controlled by the ECU 60 via the PDU 10 so as to enable the rotating angle θ_{mf} (position of the rotating angle at the electrical angle) of the magnetic flux vector of the rotating magnetic field generated when the current is applied to the coils 532 of the stator 53 and the angular velocity ω_{mf} (electrical angular velocity) which is a variation rate of the magnetic flux vector over time (differential value) to satisfy respectively the following expressions (37) and (38).

[Expression 37]

θ_{mf}=(m+1)·θₑ₂−m·θₑ₁=c{(m+1)·θ₂−m·θ₁} (37)

wherein, θ_{mf}: the rotating angle of the magnetic flux vector of the rotating magnetic field; θₑ₂: the electrical angle of the second rotor 52; θₑ₁: the electrical angle of the first rotor 51; c: the paired pole number of the armature magnetic poles; θ₂: the mechanical angle of the second rotor 52; and θ₁: the mechanical angle of the first rotor 51.

[Expression 38]

ω_{mf}=(m+1)·ωₑ₂−m·ωₑ₁=c{(m+1)·ω₂−m·ω₁} (38)

wherein, ω_{mf}: the angular velocity of the magnetic flux vector of the rotating magnetic field; ωₑ₁: the electrical angular velocity of the first rotor 51; ωₑ₂: the electrical angular velocity of the second rotor 52; c: the paired pole number of the armature magnetic poles; ω₂: the mechanical angular velocity of the second rotor 52; and ω₁: the mechanical angular velocity of the first rotor 51.

As mentioned above, by causing the stator 53 to generate the rotating magnetic field, it is possible to perform the operations of the rotary machine 3 appropriately to cause the first rotor 51 and the second rotor 52 to generate the torques. If the result obtained by dividing the supplied electrical power (the input electrical power) to the coils 532 of the stator 53 or the output electrical power from the coils 532 by the angular velocity ω_{mf} at the electrical angle of the rotating magnetic field is defined as an equivalent torque T_{mf} of the rotating magnetic field (hereinafter, referred to as the rotating magnetic field equivalent torque T_{mf}), the torque generated in the first rotor 51 is defined as T1, and the torque generated in the second rotor 52 is defined as T2, then, T_{mf}, T1 and T2 satisfy the relationship in the following expression (39). Here, the energy loss such as the copper loss, the iron loss or the like is assumed to be too minute to be ignored.

$$\begin{matrix}[ Expression 39 ] & \\ {T}_{mf} = \frac{T 1}{m} = - \frac{T 2}{m + 1} & ( 39 )\end{matrix}$$

The angular velocity relationship denoted by the above expression (38) and the torque relationship denoted by the above expression (39) are completely identical to the rotating velocity relationship and the torque relationship of a sun gear, a ring gear and a carrier gear in a planetary gear device. In other words, any one of the armature magnetic poles and the first rotor 51 corresponds to the sun gear and the other corresponds to the ring gear, and the second rotor 52 corresponds to the carrier gear.

Therefore, the rotary machine 3 has the functions of a planetary gear device (more generally, the functions of a differential device), and the rotations of the armature magnetic poles and the first rotor 51 and the second rotor 52 are carried out with the collinear relationship in the expression (38) maintained.

Thus, similar to a common planetary gear device, the rotary machine 3 has the functions of distributing and combining energies. Specifically, it is possible to distribute and combine energies among the coils 532 of the stator 53, the second rotor 52 and the first rotor 51 via a magnetic circuit formed among the stator 53, the cores 521 (soft magnetic material) of the second rotor 52 and the permanent magnets 512 of the first rotor 51.

For one example, when a load is laid on the first rotor 51 and the second rotor 52, the electrical power (electrical energy) is supplied to the coils 532 of the stator 53 to generate the rotating magnetic field, it is possible to convert the electrical energy supplied to the coils 532 via the magnetic circuit into the rotational kinetic energy of the first rotor 51 and the second rotor 52 to drive the first rotor 51 and the second rotor 52 to rotate (to generate a torque in the first rotor 51 and the second rotor 52). Thus, the electrical energy input to the coils 532 is distributed to the first rotor 51 and the second rotor 52.

For another example, when the second rotor 52 is laid with a load, the first rotor 51 is rotated from the outer side (the rotational kinetic energy is applied from the outer side to the first rotor 51) to generate the rotating magnetic field so as to output the electrical energy from the coils 532 of the stator 53 (to perform power generation by the coils 532), it is possible to convert the rotational kinetic energy via the magnetic circuit into the rotational kinetic energy of the second rotor 52 and the power generation energy of the coils 532 to drive the second rotor 52 to rotate and cause the coils 532 to perform power generation. Thus, the energy input to the first rotor 51 is distributed to the second rotor 52 and the coils 532.

For another example, when the second rotor 52 is laid with a load, the first rotor 51 is rotated from the outer side (the rotational kinetic energy is applied from the outer side to the first rotor 51) and the electrical energy is supplied to the coils 532 of the stator 53 to generate the rotating magnetic field, it is possible to convert the rotational kinetic energy applied to the first rotor 51 and the electrical energy supplied to the coils 532 via the magnetic circuit into the rotational kinetic energy of the second rotor 52 and drive the second rotor 52 to rotate. Thus, the energy input to the first rotor 51 and the energy supplied to the coils 532 are combined and transmitted to the second rotor 52.

As mentioned, in the rotary machine 3, it is possible to distribute and combine the energies among the first rotor 51, the second rotor 52 and the coils 532 while inter-converting the energies among the rotational kinetic energy of the first rotor 51, the rotational kinetic energy of the second rotor 52 and the electrical energy of the coils 532.

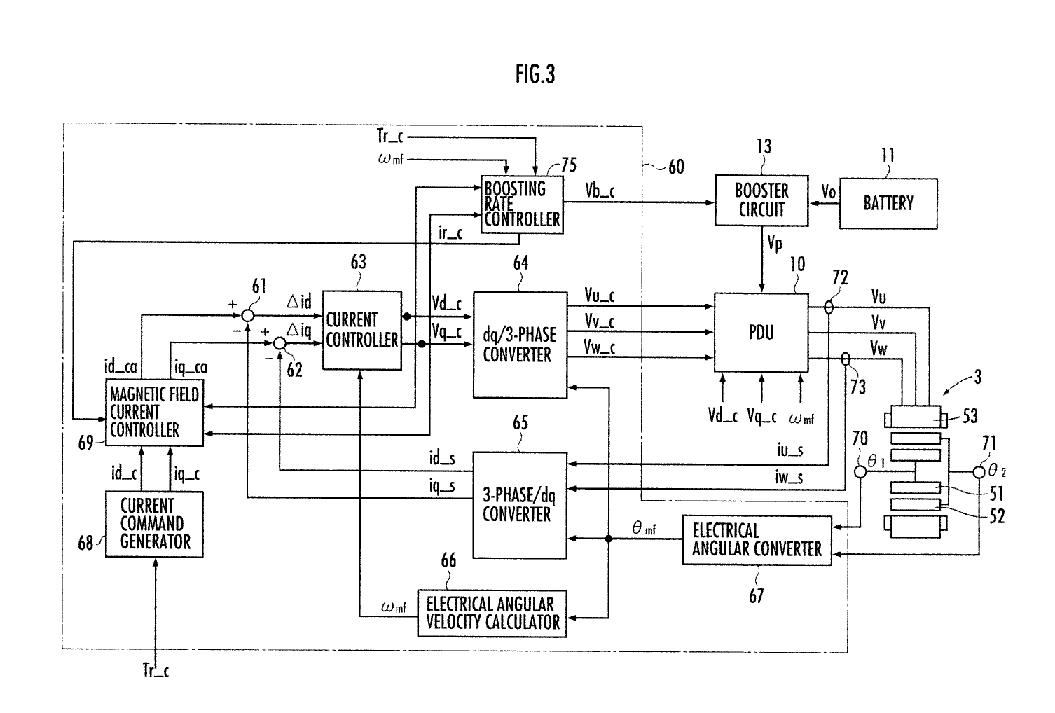

Hereinafter, with reference to FIG. 3 to FIG. 8, the configuration and the performance of the ECU 60 and the PDU 10 will be described. With reference to FIG. 3, the ECU 60 controls the current applied to the coils of each phase (phase current) of the stator 53 in the rotary machine 3 via the so-called d-q vector control. In other words, the ECU 60 treats the coils of 3 phases of the stator 53 in the rotary machine 3 by converting the coils of 3 phases of the stator 53 into an equivalent circuit in a d-q coordinate system which is a rotational coordinate system of 2-phase direct currents.

The equivalent circuit corresponding to the stator 53 includes the armatures in a d axis (hereinafter, referred to as the d-axis armature) and the armatures in a q axis (hereinafter, referred to as the q-axis armature). The d-q coordinate system is a rotational coordinate system in which the phase of the d axis with respect to the reference coils in the 3-phase coils is set at a position of the rotating angle θ_{mf} calculated according to the above expression (39), the direction orthogonal to the d axis is set as the q axis, and the first rotor 51 rotates together with the second rotor 52.

The ECU 60 is provided with an electrical angle converter 67, a 3-phase/dq converter 65 and an electrical angular velocity calculator 66. The electrical angle converter 67 is configured to calculate the rotating angle θ_{mf} from the mechanical angle θ₁ of the first rotor 51 detected by a position sensor 70 (a resolver, an encoder or the like) and the mechanical angle θ₂ of the second rotor 52 detected by a position sensor 71 according to the above expression (39). The 3-phase/dq converter 65 is configured to convert a U-phase current detection value iᵤ₋s detected by a phase current sensor 72 and a W-phase current detection value i_{w-}s detected by a phase current sensor 73 into a d-axis current detection value i_{d-}s which is a detection value of a current flowing in the coils of the d-axis armature (hereinafter, referred to as the d-axis current) and a q-axis current detection value i_{q-}s which is a detection value of a current flowing in the coils of the q-axis armature (hereinafter, referred to as the q-axis current). The electrical angular velocity calculator 66 is configured to calculate the electrical angular velocity ω_{mf} through differentiating the rotating angle θ_{mf}.

The ECU 60 is further provided with a current command generator 68, a magnetic field current controller 69, a subtractor 61, a subtractor 62, a current controller 63 and a dq/3-phase converter 64. The current command generator 68 is configured to generate a d-axis current command value i_{d-}c which is a command value of the d-axis current (magnetic field current) and a q-axis current command value i_{q-}c which is a command value of the q-axis current (torque current) according to a torque command value Tr_c (equivalent to the required operation state of the present invention) applied from the outer side. The magnetic field current controller 69 is configured to correct the currents (magnetic field weakening current) for reducing the counter electromotive voltage occurred in the armature coils of the stator 53 due to the rotation of the first rotor 51 and the second rotor 52 into the d-axis current command value i_{d-}ca supplied to the d-axis armature coil and the q-axis current command value i_{q-}ca. The subtractor 61 is configured to calculate the difference Δi_{d} between the d-axis current command value i_{d-}c and the d-axis current detection value i_{d-}s. The subtractor 62 is configured to calculate the difference Δi_{q} between the q-axis current command value i_{q-}c and the q-axis current detection value i_{q-}s. The current controller 63 is configured to determine a d-axis voltage command value V_{d}_{_{—}}c (equivalent to the voltage command value of the present invention) which is a command value of voltage between the terminals of the coils of the d-axis armature so as to reduce Δi_{d} and a q-axis voltage command value V_{q}_{_{—}}c (equivalent to the voltage command value of the present invention) which is a command value of voltage between the terminals of the coils of the q-axis armature so as to reduce Δi_{q}. The dq/3-phase converter 64 is configured to convert the d-axis voltage command value V_{d}_{_{—}}c and the q-axis voltage command value V_{q}_{_{—}}c into the command values of 3-phase voltage, namely a U-phase voltage command value Vᵤ_{_{—}}c, a V-phase voltage command value Vᵥ_{_{—}}c and a W-phase voltage command value V_{w}_{_{—}}c on the basis of the rotating angle θ_{mf}.

The magnetic field current controller 69 generates the d-axis current command value i_{d-}ca and the q-axis current command value i_{q-}ca according to a correction by conducting the magnetic field weakening current when the magnitude (√(V_{d}_{_{—}}c²+V_{q}_{_{—}}c²)) of the vector sum of the d-axis voltage command value V_{d}_{_{—}}c and the q-axis voltage command value V_{q}_{_{—}}c is greater than an upper voltage limit Vᵤₗₘₜ.

In addition, the d-axis voltage command value V_{d}_{_{—}}c and the q-axis voltage command value V_{q}_{_{—}}c are also corrected as a result of the correction on the d-axis current command value i_{d-}c and the q-axis current command value i_{q-}c.

The PDU 10 performs an energization control on the 3-phase coils of the stator 53 in the rotary machine 3 from the electrical power supplied from the battery 11 via the booster circuit 13 by performing a PWM control to switch switching elements (transistor and the like) constituting the inverter according to Vᵤ_{_{—}}c, Vᵥ_{_{—}}c and V_{w}_{_{—}}c. The boosting rate of the booster circuit 13 for an output voltage by the battery 11 is determined by a boosting rate controller 75 on the basis of the torque command value Tr-c and the electrical angular velocity ω_{mf}.

As the electrical angular velocity ω_{mf} of the rotary machine 3 increases, the counter electromotive voltage occurred in the armature coils of the stator 53 becomes greater. As the counter electromotive voltage is greater than an output voltage Vₒ of the battery 11, it would be impossible to energize the rotary machine 3 from the PDU 10, which makes the torque control of the rotary machine 3 impossible.

Therefore, the ECU 60 extends the available range of the torque control of the rotary machine 3 by performing at least one process in (1) a first process (magnetic field weakening process) which causes the magnetic field current controller 69 to generate the d-axis current command value i_{d-}ca and the q-axis current command value i_{q-}ca according to a correction by conducting the magnetic field weakening current and (2) a second process (voltage boosting process) which causes the boosting rate controller 75 to make the boosting rate of the booster circuit 13 for the output voltage V₀ of the battery 11 greater than 1 so as to increase an voltage Vp supplied to the PDU 10 greater than Vₒ. The first process and the second process will be described hereinafter.

### First Embodiment

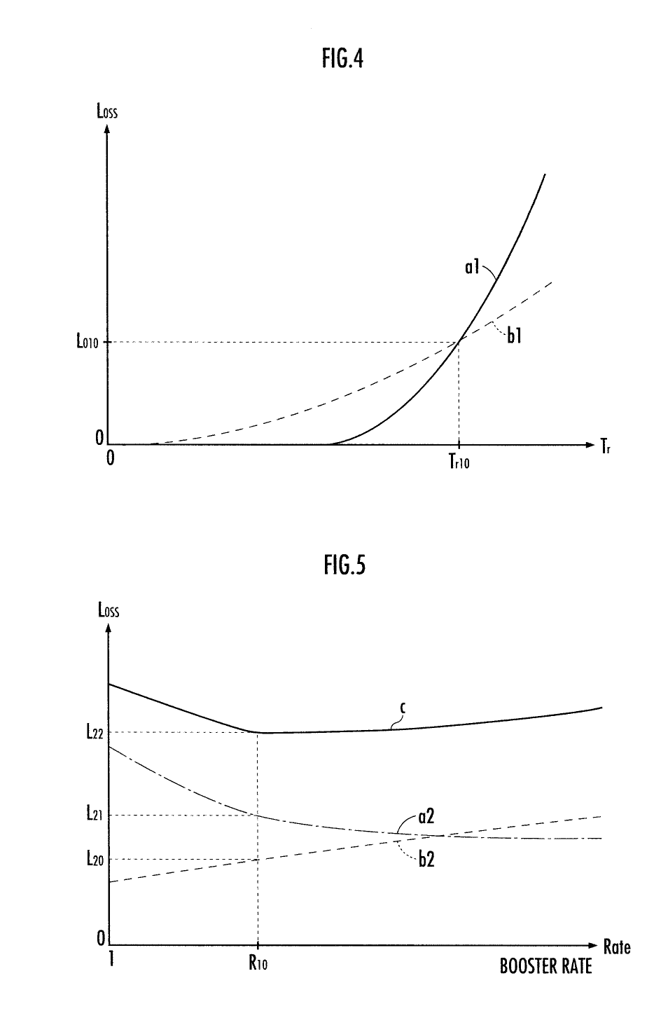

Firstly, a first embodiment of the first process and the second process performed by the ECU60 will be described. In the first embodiment, the boosting rate controller 75 determines which process in the first process and the second process should be performed in priority according to a torque-loss correlation map illustrated in FIG. 4.

The correlation map of FIG. 4 having the loss (Loss) being set as the vertical axis and the torque (Tr) being set as the horizontal axis exhibits a loss (first loss) a₁ occurred in performing only the first process and a loss (second loss) b₁ occurred in performing only the second process at an electrical angular velocity greater than a predefined upper velocity limit in order to acquire the required torque of the rotary machine 3.

In the correlation map of FIG. 4, when the torque is not greater than Tr₁₀, the first loss occurred in performing the first process is smaller than the second loss occurred in performing the second process. On the opposite, when the torque is greater than Tr₁₀, the second loss occurred in performing the second process is smaller than the first loss occurred in performing the first process.

Thus, when the torque command value Tr_c is not greater than Tr₁₀, the boosting rate controller 75 performs the first process (magnetic field weakening process). On the other hand, when the torque command value Tr_c is greater than Tr₁₀, the boosting rate controller 75 performs the second process (voltage boosting process). Thereby, it is possible to inhibit the occurrence of loss, and consequently to extend the upper limit of electrical angular velocity in the control range of the rotary machine 3.

The boosting rate controller 75 sets the boosting rate of the booster circuit 13 for the output voltage V₀ of the battery 11 by outputting a boosting rate command value V_{b}_{_{—}}c to the booster circuit 13. Moreover, the boosting rate controller 75 determines the correction amount for the d-axis current command value i_{d-}c and the q-axis current command value i_{q-}c by outputting a magnetic field current command value iᵣ_{_{—}}c to the magnetic field current controller 69.

### Second Embodiment

Hereinafter, a second embodiment of the first process and the second process performed by the ECU60 will be described. In the second embodiment, the boosting rate controller 75 determines the magnetic field weakening setting for the first process and the boosting rate setting for the second process when both of the first process and the second process are performed according to a boosting rate-loss correlation map illustrated in FIG. 5.

The correlation map of FIG. 5 having the loss (Loss) being set as the vertical axis and the boosting rate (Rate) being set as the horizontal axis exhibits the variation of loss when both of the first process (magnetic field weakening process) and the second process (voltage boosting process) are performed on condition that the magnitude (√(V_{d}_{_{—}}c²+V_{q}_{_{—}}c²)) of the vector sum of the d-axis voltage command value V_{d}_{_{—}}c and the q-axis voltage command value V_{q}_{_{—}}c is greater than the upper voltage limit Vᵤₗₘₜ in an attempt to output from the rotary machine 3 a torque according to the torque command value Tr_c with the torque current (q-axis current) only.

In FIG. 5, a₁ denotes the loss (the first loss) occurred in the rotary machine 3 due to performing the first process, b₁ denotes the loss (the second loss) occurred in the booster circuit 13 due to performing the second process, and c denotes the total loss (the sum of the first loss and the second loss) occurred due to performing the first process and the second process.

In the correlation map of FIG. 5, when the boosting rate of the booster circuit 13 is set to R₁₀, the total loss c is at the minimum (L₂₂). Therefore, the boosting rate controller 75 sets the boosting rate of the booster circuit 13 to R₁₀. The correction amount for the magnetic field current controller 69 to generate the magnetic field weakening current is set equivalent to the loss L₂₁ of a₂ corresponding to R₁₀.

Thereby, by determining the boosting rate of the booster circuit 13 and the correction amount for the magnetic field current controller 69, it is possible to inhibit the total loss in the rotary machine 3 and the booster circuit 13 to the minimum, and consequently to extend the controllable range of the rotary machine 3.

### Third Embodiment

Hereinafter, together with the first embodiment and the second embodiment or independent from the first embodiment and the second embodiment, a generation process of the drive voltages Vᵤ, Vᵥ and V_{w} performed by the PDU 10 will be described.

The PDU 10 generates the drive voltages Vᵤ, Vᵥ and V_{w} according to a 3-phase modulation when the electrical angular velocity ω_{mf} is equal to or lower than a predefined upper velocity limit. When the electrical angular velocity ω_{mf} is greater then the upper velocity limit, the PDU 10 generates the drive voltages Vᵤ, V₁ and V_{w} according to a 2-phase modulation. Thereby, it is possible to reduce the switching frequency of the switching elements (transistor and the like) in the inverter circuit of the PDU 10 in a high-velocity rotating region, and consequently to reduce the switching loss.

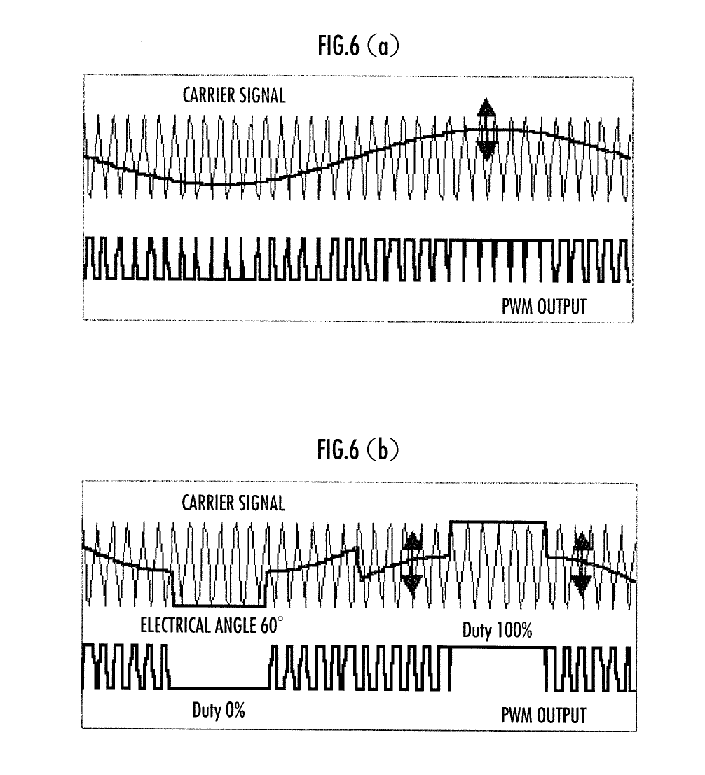

Hereinafter, with reference to FIG. 6 to FIG. 8, the generation process of the drive voltages Vᵤ, Vᵥ and V_{w} according to the 2-phase modulation will be described. FIG. 6(a) illustrates one phase of the drive voltages generated according to the 3-phase modulation. In the 3-phase modulation, since the Duty switching is performed according to PWM control in the whole region, the switching frequency of the switching elements in the PDU 10 is great.

FIG. 6(b) illustrates one phase of the drive voltages generated according to the 2-phase modulation. In the 2-phase modulation, Duty is set to 0% or 100% in a range of electrical angle 60°; therefore, the switching elements in the PDU 10 will not be switched in this section. Thereby, the switching frequency of the switching elements is less than that in the 3-phase modulation.

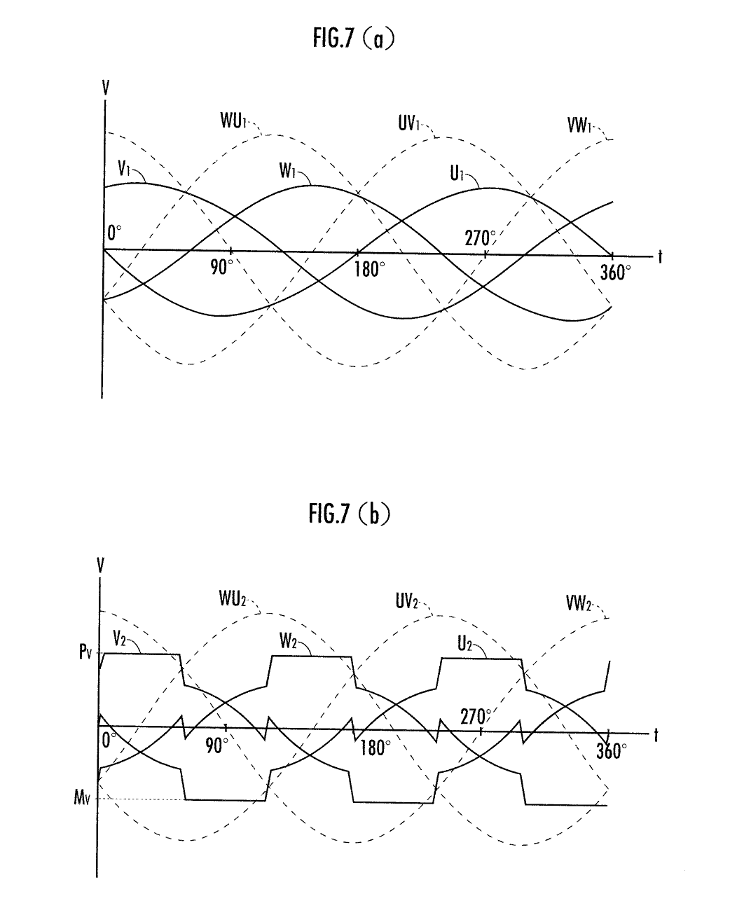

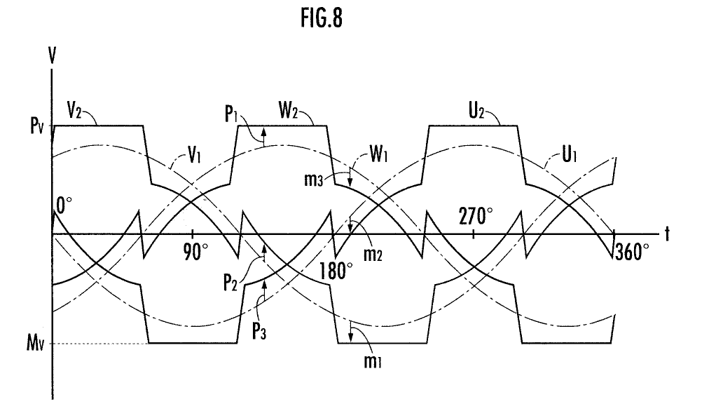

The wave shapes of the 3-phase drive voltages U₁, V₁ and W₁ generated according to the 3-phase modulation and the inter-phase voltages UV₁, VW₁ and WU₁ are illustrated in FIG. 7(a) having the voltage (V) set as the vertical axis and the time (t) set as the horizontal axis. Meanwhile, the wave shapes of the 3-phase drive voltages U₂, V₂ and W₂ generated according to the 2-phase modulation and the inter-phase voltages UV₂, VW₂ and WU₂ are illustrated in FIG. 7(b) having the voltage (V) set as the vertical axis and the time (t) set as the horizontal axis.

By comparing FIG. 7(a) with FIG. 7(b), it is clear that although the wave shapes of the drive voltages U₁, V₁ and W₁ generated according to the 3-phase modulation are different from the wave shapes of the drive voltages U₂, V₂ and W₂ generated according to the 2-phase modulation, the wave shapes of the inter-phase voltages UV₁, VW₁ and WU₁ generated according to the 3-phase modulation are the same as the wave shapes of the inter-phase voltages UV₂, VW₂ and WU₂ generated according to the 2-phase modulation.

Since the voltage (inter-phase voltage) applied to the armature coils of the stator 53 of the rotary machine 3 in the 3-phase modulation is the same as in the 2-phase modulation, the output of the rotary machine 3 remains the same as well.

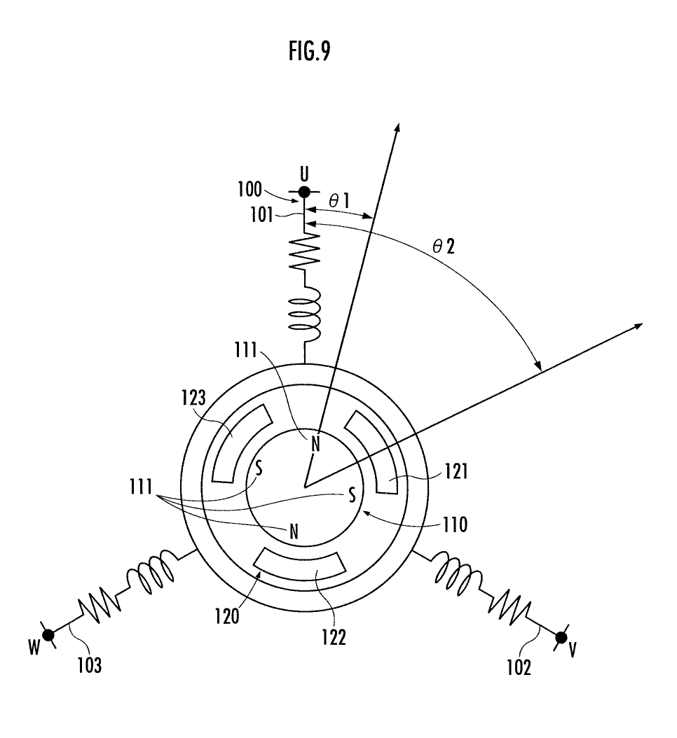

A generation method of the drive voltages according to the 2-phase modulation is illustrated in FIG. 8. For example, on the positive side, the drive voltage W₂ generated according to the 2-phase modulation is obtained by replacing the drive voltage W₁ generated according to the 3-phase modulation in the range of 120° to 180° with the voltage Pv having a Duty level of 100%. According to the offset p₁ for the replacement, the other drive voltages V₁ and W₁ by the 3-phase modulation are also added with the offsets p₂ and p₃ to generate the drive voltages U₂, V₂ by the 2-phase modulation.

Similarly, on the negative side, the drive voltage V₂ generated according to the 2-phase modulation is obtained by replacing the drive voltage V₁ generated according to the 3-phase modulation in the range of 180° to 240° with the voltage Mv having a Duty level of 0%. According to the offset m₁ for the replacement, the other drive voltages U₁ and W₁ by the 3-phase modulation are also added with the offsets m₂ and m₃ to generate the drive voltages U₂, V₂ by the 2-phase modulation.

It is acceptable that the drive voltages are generated according to whether or not the magnitude (√(V_{d}_{_{—}}c²+V_{q}_{_{—}}c²)) of the vector sum of the d-axis voltage command value V_{d}_{_{—}}c and the q-axis voltage command value V_{q}_{_{—}}c is not greater than the upper voltage limit Vᵤₗₘₜ. When the magnitude of the vector sum is not greater than the upper voltage limit Vᵤₗₘₜ, the drive voltages are generated according to the 3-phase modulation; however, when the magnitude of the vector sum is greater than the upper voltage limit Vᵤₗₘₜ, the drive voltages are generated according to the 2-phase modulation.

It is acceptable that the drive voltages are generated according to whether or not the electrical angular velocity ω_{mf} is not greater than the upper velocity limit. When the electrical angular velocity ω_{mf} is not greater than the upper velocity limit, the drive voltages Vᵤ, Vᵥ, and V_{w}, are generated according to sinusoidal energization; however, when the electrical angular velocity ω_{mf} is greater than the upper velocity limit, the drive voltages Vᵤ, Vᵥ and V_{w} are generated via rectangular energization.

It is acceptable that the drive voltages are generated according to whether or not the magnitude (√(V_{d}_{_{—}}c²+V_{q}_{_{—}}c²)) of the vector sum of the d-axis voltage command value V_{d}_{_{—}}c and the q-axis voltage command value V_{q}_{_{—}}c is not greater than the upper voltage limit Vᵤₗₘₜ. When the magnitude of the vector sum is not greater than the upper voltage limit Vᵤₗₘₜ, the drive voltages Vᵤ, Vᵥ and V_{w} are generated according to sinusoidal energization; however, when the magnitude of the vector sum is greater than the upper voltage limit Vᵤₗₘₜ, the drive voltages Vᵤ, Vᵥ and V_{w} are generated via rectangular energization.

In the present embodiment, the stator 53 of the rotary machine 3 is provided with 3 phases of coils to generate the rotating magnetic field (shifting magnetic field); however, it is acceptable for it to have coils having phases other than 3 to generate the rotating magnetic field.

In the present embodiment, the rotary machine 3 is described as the motor of the present invention; however, the present invention may be applied to a directing acting machine (linear motor) to obtain the same effects.

In the present embodiment, the rotary machine 3 is converted into an equivalent circuit in the d-q coordinate system and controlled by the ECU 60; however, the effects of the present invention may be obtained by performing the current conduction to the 3-phase coils 532 of the stator 53 of the rotary machine 3 without the conversion of the equivalent circuit as long as the relationship in the above expression (37) or (38) is maintained valid.

### INDUSTRIAL APPLICABILITY

As mentioned in the above, according to the motor system of the present invention, it is possible to reduce the size of the motor and to improve the design freedom thereof so as to extend an usable range for the motor; therefore, it is usable to apply the motor system where appropriate.

What is claimed is:

1. A motor system, comprising:
an electric motor which is provided with
a first mover composed of a magnetic pole array which has a plurality of magnetic poles arranged along a predefined direction,
a stator composed of an armature array which is provided with a plurality of armatures aligned along the predefined direction, arranged opposing to the magnetic pole array and configured to generate a shifting magnetic field shifting along the predefined direction between the armature array and the magnetic pole array from armature magnetic poles generated in the plurality of armatures when applied with an electrical power, and
a second mover having a core portion and another portion of a magnetic permeability lower than the core portion alternatively disposed between the magnetic pole array and the armature array along the predefined direction,
and the electric motor being configured to have a ratio of the number of the armature magnetic poles and the number of the magnetic poles and the number of the core portions set to 1: m: (1+m)/2 (m≠1.0),
a power source,
a controller configured to determine a voltage command value which is a command value of a voltage to be supplied to coils of the armature according to a predefined required operation state, and correct the voltage command value so as to generate a magnetic field weakening current to reduce a magnetic flux of the magnetic poles on condition that the voltage command value is greater than an upper voltage limit set according to an output voltage of the power source or a velocity of the shifting magnetic field is greater than a predefined upper velocity limit, and
a drive circuit configured to generate a drive voltage from the output power of the power source according to the voltage command value and supply the drive voltage to the coils of the armature.

2. The motor system according to claim 1, wherein when the controller is correcting the voltage command value so as to cause the drive circuit to supply the drive voltage to the coils of the armature on condition that the voltage command value is greater than the upper voltage limit, the controller stops correcting the voltage command value on condition that the voltage command value becomes equal to or lower than the upper voltage limit.

3. The motor system according to claim 1, wherein when the controller is correcting the voltage command value so as to cause the drive circuit to supply the drive voltage to the coils of the armature on condition that the velocity of the shifting magnetic field is greater than the upper velocity limit, the controller stops correcting the voltage command value on condition that the velocity of the shifting magnetic field becomes equal to or lower than the upper velocity limit.

4. A motor system, comprising:
an electric motor which is provided with
a first mover composed of a magnetic pole array which has a plurality of magnetic poles arranged along a predefined direction,
a stator composed of an armature array which is provided with a plurality of armatures aligned along the predefined direction, arranged opposing to the magnetic pole array and configured to generate a shifting magnetic field shifting along the predefined direction between the armature array and the magnetic pole array from armature magnetic poles generated in the plurality of armatures when applied with an electrical power, and
a second mover having a core portion and another portion of a magnetic permeability lower than the core portion alternatively disposed between the magnetic pole array and the armature array along the predefined direction,
and the electric motor being configured to have a ratio of the number of the armature magnetic poles and the number of the magnetic poles and the number of the core portions set to 1: m: (1+m)/2 (m≠1.0),
a power source,
a booster circuit configured to boost an output voltage of the power source,
a controller configured to determine a voltage command value which is a command value of a voltage to be supplied to coils of the armature according to a predefined required operation state, and cause the booster circuit to boost the output voltage of the power source on condition that the voltage command value is greater than an upper voltage limit set according to an output voltage of the power source or a velocity of the shifting magnetic field is greater than a predefined upper velocity limit, and
a drive circuit configured to generate a drive voltage from the output power of the power source according to the voltage command value and supply the drive voltage to the coils of the armature.

5. The motor system according to claim 4, wherein when the controller is causing the booster circuit to boost the output voltage of the power source so as to cause the drive circuit to supply the drive voltage to the coils of the armature on condition that the voltage command value is greater than the upper voltage limit, the controller stops boosting the output voltage of the power source via the booster circuit on condition that the voltage command value becomes equal to or lower than the upper voltage limit.

6. The motor system according to claim 4, wherein when the controller is causing the booster circuit to boost the output voltage of the power source so as to cause the drive circuit to supply the drive voltage to the coils of the armature on condition that the velocity of the shifting magnetic field is greater than the upper velocity limit, the controller stops boosting the output voltage of the power source via the booster circuit on condition that the velocity of the shifting magnetic field becomes equal to or lower than the upper velocity limit.

7. A motor system, comprising:
an electric motor which is provided with
a first mover composed of a magnetic pole array which has a plurality of magnetic poles arranged along a predefined direction,
a stator composed of an armature array which is provided with a plurality of armatures aligned along the predefined direction, arranged opposing to the magnetic pole array and configured to generate a shifting magnetic field shifting along the predefined direction between the armature array and the magnetic pole array from armature magnetic poles generated in the plurality of armatures when applied with electrical power, and
a second mover having a core portion and another portion of a magnetic permeability lower than the core portion alternatively disposed between the magnetic pole array and the armature array along the predefined direction,
and the electric motor being configured to have a ratio of the number of the armature magnetic poles and the number of the magnetic poles and the number of the core portions set to 1: m: (1+m)/2 (m≠1.0),
a power source,
a booster circuit configured to boost an output voltage of the power source,
a controller configured to determine a voltage command value which is a command value of a voltage to be supplied to coils of the armature according to a predefined required operation state, estimate a first loss occurred in performing a first process for correcting the voltage command value so as to generate a magnetic field weakening current to reduce a magnetic flux of the magnetic poles and a second loss occurred in performing a second process for causing the booster circuit to boost the output voltage of the power source on condition that the voltage command value is greater than an upper voltage limit set according to an output voltage of the power source, and determine a correcting level and a boosting level on the basis of the estimation results of the first loss and the second loss, respectively, and
a drive circuit configured to generate a drive voltage from the output power of the power source according to the voltage command value and supply the drive voltage to the coils of the armature.

8. The motor system according to claim 7, wherein the controller prioritizes a process in the first process and the second process which would have a smaller loss.

9. The motor system according to claim 7, wherein the controller determines a correcting level for the first process and a boosting level for the second process to boost the output voltage of the power source so as to minimize the sum of the first loss and the second loss.

10. A motor system, comprising:
an electric motor which is provided with
a first mover composed of a magnetic pole array which has a plurality of magnetic poles arranged along a predefined direction,
a stator composed of an armature array which is provided with a plurality of armatures aligned along the predefined direction, arranged opposing to the magnetic pole array and configured to generate a shifting magnetic field shifting along the predefined direction between the armature array and the magnetic pole array from armature magnetic poles generated in the plurality of armatures when applied with electrical power, and
a second mover having a core portion and another portion of a magnetic permeability lower than the core portion alternatively disposed between the magnetic pole array and the armature array along the predefined direction,
and the electric motor being configured to have a ratio of the number of the armature magnetic poles and the number of the magnetic poles and the number of the core portions set to 1: m: (1+m)/2 (m≠1.0),
a power source,
a controller configured to determine a voltage command value which is a command value of a voltage to be supplied to coils of the armature according to a predefined required operation state, and
a drive circuit configured to generate a drive voltage from the output power of the power source according to the voltage command value, supply the drive voltage to the coils of the armature, and switch generation behaviors for generating the drive voltage according to whether or not the voltage command value is equal to or lower than an upper voltage limit set according to an output voltage of the power source or a velocity of the shifting magnetic field is equal to or lower than a predefined upper velocity limit.

11. The motor system according to claim 10, wherein the drive circuit generates the drive voltage according to the voltage command value via sinusoidal energization on condition that the voltage command value is equal to or lower than the upper voltage limit, and generates the drive voltage according to the voltage command value via rectangular energization on condition that the voltage command value is greater than the upper voltage limit.

12. The motor system according to claim 10, wherein the drive circuit generates the drive voltage according to the voltage command value by performing a 3-phase modulation to vary voltages applied to the coils of the armatures of 3 phases on condition that the voltage command value is equal to or lower than the upper voltage limit, and generates the drive voltage according to the voltage command value by performing a 2-phase modulation to vary only voltages applied to the coils of the armatures of 2 phases in the 3 phases on condition that the voltage command value is greater than the upper voltage limit.

13. The motor system according to claim 10, wherein the drive circuit generates the drive voltage according to the voltage command value via sinusoidal energization on condition that the velocity of the shifting magnetic field is equal to or lower than the upper velocity limit, and generates the drive voltage according to the voltage command value via rectangular energization on condition that the velocity of the shifting magnetic field is greater than the upper velocity limit.

14. The motor system according to claim 10, wherein the drive circuit generates the drive voltage according to the voltage command value by performing a 3-phase modulation to vary voltages applied to the coils of the armatures of 3 phases on condition that the velocity of the shifting magnetic field is equal to or lower than the upper velocity limit, and generates the drive voltage according to the voltage command value by performing a 2-phase modulation to vary only voltages applied to the coils of the armatures of 2 phases in the 3 phases on condition that the velocity of the shifting magnetic field is greater than the upper velocity limit.
